(19) United States
(12) Patent Application Publication
(10) Pub. No.: US 2006/0171815 A1
(43) Pub. Date: Aug. 3, 2006

(54) Electro-magnetic air blower

(76) Inventor: Charles L. Waid, Las Vegas, NV (US)

Correspondence Address: JACOBSON HOLMAN PLLC, 400 SEVENTH STREET N.W., SUITE 600, WASHINGTON, DC, 20004, US

(21) Appl. No.: 11/235,218

(22) Filed: Sep. 27, 2005

Related U.S. Application Data
(60) Provisional application No. 60/650,442, filed on Feb. 1, 2005.

(51) Int. Cl. H02K 44/00

(52) U.S. Cl. 417/50

(57) ABSTRACT

An electro-magnetic air blower is a replacement for a traditional supercharger and turbocharger used on an internal combustion engin, both gasoline and diesel engines. The device includes two parts, both of which are identical in form and structure. Each of the two device measures three inches in diameter and is two inches in length. A positively charged grid, henceforth referred to as the front part, and a negatively charged grid, referred to as the rear part, are connected to each other via a bayonet clamp. The device comes after the air filter but before the intake manifold. The front part is given a positive electrical charge in order to give the air passing over it a positive charge, the rear part is given a powerful negative charge which will pull the positively charged air to the rear at high speed. The air exits the rear grid and goes directly into the intake manifold. The positively charged air will lose it's positive charge when it passes over the negatively charged grid.

This application is a complete application claiming benefit of provisional application 60/650,442, filed Feb. 1, 2005.

### BACKGROUND OF THE INVENTION

The following six patents are related to a connection to the internal combustion engine's air intake system. All of these devices do something to the fuel air mixture before it enters the engine itself. The present invention has nothing to do with the fuel air mixture, it just fulfills the function of a turbocharged or supercharged engine but without all the plumbing of these systems, the extra weight they bring to a car, and no need for an intercooler.

U.S. Pat. No. 4,011,843 (Mar. 15, 1977)

U.S. Pat. No. 4,434,771 (Mar. 6, 1984)

U.S. Pat. No. 4,308,844 (Jan. 5, 1982)

U.S. Pat. No. 5,111,797 (May 12, 1992)

U.S. Pat. No. 5,487,874 (Jan. 30, 1996)

U.S. Pat. No. 1,873,746 (Aug. 23, 1932)

### SUMMARY OF THE INVENTION

An electro-magnetic air blower of the present invention is a replacement for a traditional supercharger and turbocharger used on an internal combustion engine, both gasoline and diesel engines.

The device includes two parts, both of which are identical in form and structure. Each of the two devices measure three inches in diameter and is two inches in length. A positively charged grid, henceforth referred to as the front part, and a negatively charged grid, referred to as the rear part, are connected to each other via a bayonet clamp. The device is located in the air flow path of an internal combustion engine after the air filter but before the intake manifold.

The front part is given a positive electrical charge in order to give the air passing over it a positive charge. The rear part is given a powerful negative charge which will pull the positively charged air to the rear at high speed. The air exits the rear grid and goes directly into the intake manifold. The positively charged air will lose it's positive charge when it passes over the negatively charged grid.

The ratio of power used to make the device-work is equal in terms of how much power is used to create the positive and negative grids. However, to achieve a maximum rate of air flow through the device the ratio of power used should be at least 20 to 1. Twenty watts used to create a negative grid, one watt used to create the positive grid. As an example, the wattage at maximum power will be 1,500 watts to create the negative grid, 75 watts to create the positive grid.

The computer in the car's engine management system (EMS) will control the raising and lowering of the current to the device depending on the engine's RPM at the moment. Thus, the power level that the device operates at is not dependent on the rate of the exhaust from the exhaust manifold, or the speed of the rotation of the crankshaft, as in a supercharged engine. The EMS could tie the power level sent to the electro-magnetic air blower (EMAB) to the speed of the crankshaft, but it is not required. For instance, at startup of the engine the power level of the current sent to the EMAB could be at maximum level, briefly if needed.

The device consists of a tube three inches in diameter on the outside, 2.5 inches on the inside. The outer shell is thus 0.25 inches thick. The shell could be made of plastic, carbon fiber, titanium or even glass, as long as it does not conduct electricity and is very stiff and rigid. The device is two inches in length. Since two are required to make the system work, the total length of the system is four inches when the front and rear parts are connected to each other via a bayonet grip.

The inside of the circular device consists of nine concentric rings. All rings are one inch high. The rings should be as thin as razor blades. They will be made out of whatever conducts electricity best, but still be stiff and rigid.

In order to work, this device must be built with precession. Computer modeling is possible and would shed light on the full potential of the device. FIG. 3 demonstrates the relationship of the device to the rest of the car's air intake system.

The device will have to be removed from the car and the negative grid cleaned-every 5000 miles, at the same time the oil and air filter are replaced, for instance. A side effect of the operation of the negative grid will be to make the air super clean before it enters the intake manifold.

The nine concentric rings will be held in place by one or two brace bars at both ends of each device. These brace bars also carry the electric current in and out of the device.

The object of the invention is to maximize the area of the concentric rings exposed to the air while at the same time keeping the device as small as possible so that the device can be fitted into the small space between the car's air filter and the opening to the intake manifold. The inside diameter is 2.5 inches so that if the EMAB's electrical system were to ever fail the engine will continue to function as a normally aspirated engine.

The device of the present invention moves air from point A to point B with no moving parts, is silent in operation, produces no vibration when operating, is small and compact in size, and uses electricity as the sole source of power to function.

Inside each device are nine concentric rings, one inch high, the diameter of the smallest ring is 0.25 inches, the diameter of the largest ring is 2.25 inches. The total surface of the nine concentric rings, both sides exposed to the air as it passes over the rings is 70 square inches. The rings are spaced ⅛ of an inch apart from each other.

The nine concentric rings are held in place by brace bars at the front and rear of each device. Two brace bars could be used at each end. The brace bars will also carry the electric current in and out of each device.

The number of concentric rings could be increased or decreased to create different sized devices for different needs and purposes.

The rings must be as thin as razor blades and stiff and rigid. The material used for the blades will be whatever conducts electricity best and conforms to the first requirement of being rigid.

The ratio of power used to drive the device will be at least 20 to 1, negative to positive, twenty watts to create the negative grid, one watt to create the positive grid. This 20 to 1 ratio could be increased to at least 30 to 1 or even 50 to 1.

The EMAB is really a system with two parts, both of which are identical to each other in all respects. The front device is given a positive electrical charge, the rear device is given a powerful negative charge. The total maximum amount of electric power used will be 1,575 watts, or two horsepower. That is 75 watts to the positive grid, 1,500 watts to the negative grid.

The device could function as a small fan in a car's heating and air conditioning system, would be silent and produce no vibrations.

The device performs the same function as a traditional turbocharger or supercharger, but without all the plumbing and weight of the plumbing, no intercooler is needed, and there is no vibration. The device is significantly smaller than the turbochargers and superchargers it replaces.

The device as described could even function as an electric jet engine with significant increases in the level of electric power used.

The device could even be tested under water, sea water, and act as a silent propulsion system for a submarine. In this case the basic design would have to be modified, but the principal and the concept would remain the same. No super cooling would be required.

These and other objects of the invention, as well as many of the intended advantages thereof, will become more readily apparent when reference is made to the following description taken in conjunction with the accompanying drawings.

### BRIEF DESCRIPTION OF THE FIGURES

FIG. 1 is a side view of the device, two are required for the system to work. The front device is given a positive electrical charge. The rear is given a powerful negative charge. The rear device pulls the air out of the front grid and feeds it into the intake manifold at high speed, both the positive charged grid, the front device, and the negative charged grid, the rear device, are identical in form and structure, being different only in the type and level of electric current sent to them.

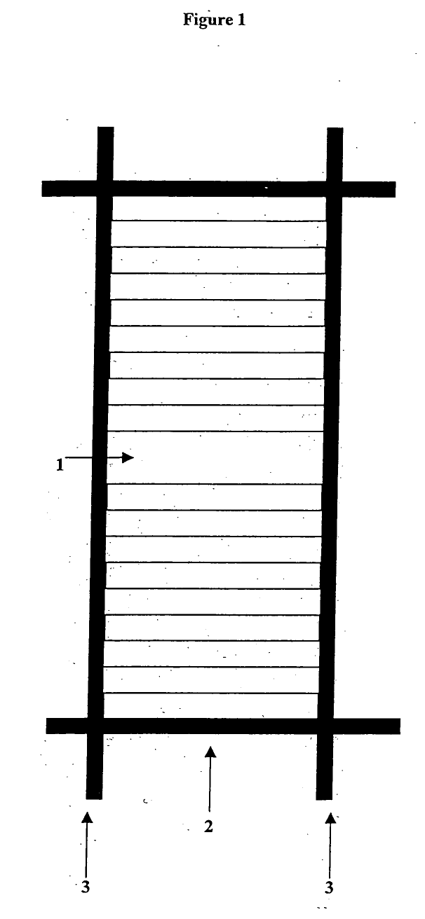

FIG. 2 is a view of the device as seen from the top, or bottom, head on showing the nine concentric rings and the brace bars.

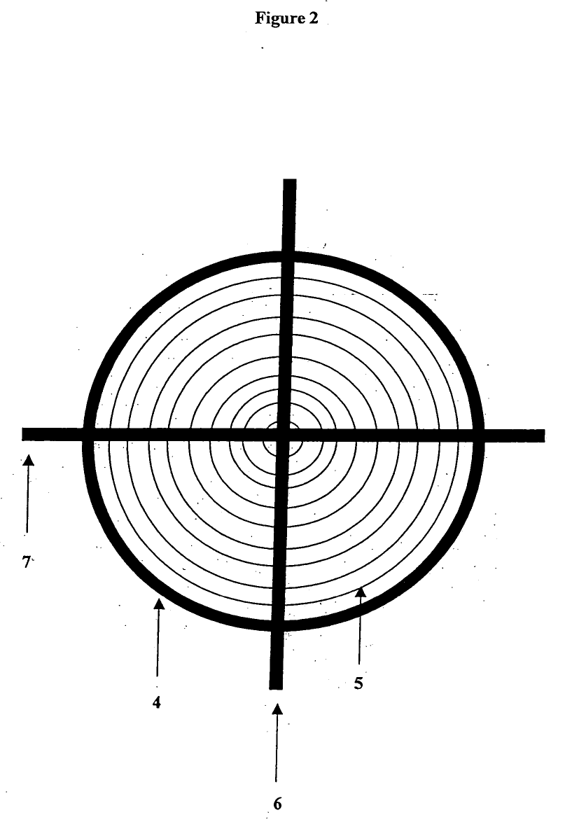

FIG. 3 is a diagram showing the relative position of the EMAB to the rest of the car's air intake system and the engine as a whole.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

The center concentric ring 1 is one inch high and 0.25 inches in diameter. The next successive radially outward eight rings are wrapped around the center, spread only ⅛ of an inch apart from the next inner or outer ring. The outer shell 2, is made out of plastic, carbon fiber, glass or titanium. It must not conduct electricity and must be stiff and rigid. The brace bars 3 are at the front and rear of each device. They should be placed at 90 degree angles to each other. Three bars radiating from the center could also be used. They should be welded in place. These bars also carry the electric current in and out of the device. The outer shell 4 of the device is seen from either end. The nine concentric rings 5 are as thin as razor blades. The brace bars 6 are at the front of the device. The brace bars 7 are at the rear of the device.

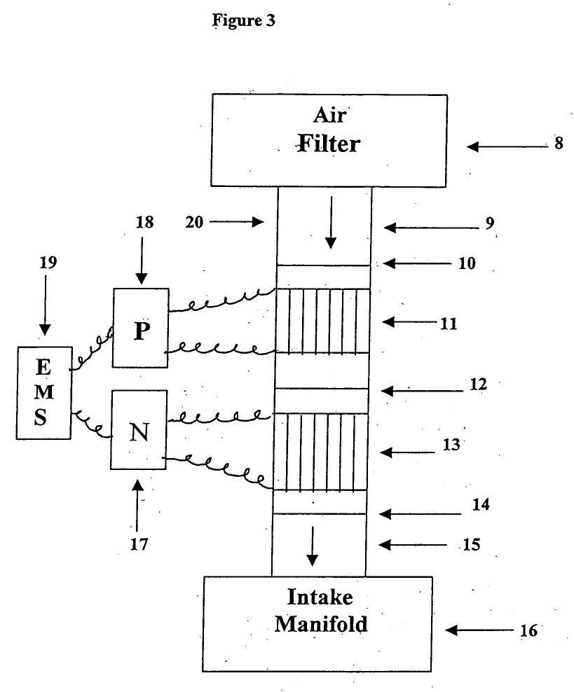

In FIG. 3, the car's air filter 8 and the connecting tube 9 connects the air filter to the positive grid 11. Connection point 10 for the positive grid to the tube leads out from the air filter.

The positive charged grid 11 is connected by the bayonet grip 12, connecting the positive grid to the negative grid 13. Connection point 14 for the negative grid to the tube 15 leads into the intake manifold 16. The connecting tube 15 connects the negative grid 13 to the intake manifold 16, sometimes called the plenum chamber.

The electrical system 17 generates the powerful negative charge on the negative grid 13. The electrical system 18 generates the positive charged grid 11. The engine management system 19 controls the operations of the engine and the electrical systems that create the positive and negative charged grids. Arrows 20 shows the direction of increased air flow from the air filter into the intake manifold as a result of the positively charged particles being attracted by negatively charged particles, charged to a much larger degree than the positively charged particles.

The foregoing description should be considered as illustrative only of the principles of the invention. Since numerous modifications and changes will readily occur to those skilled in the art, it is not desired to limit the invention to the exact construction and operation shown and described, and, accordingly, all suitable modifications and equivalents may be resorted to, falling within the scope of the invention.

I claim:

1. An electro-magnetic air blower comprising two devices positioned adjacent to each other:
a first one of the two devices being positively charged,
a second one of the two devices being negatively charged,
a ratio of a charge of the second device to the first device being at least 20 to 1 to rapidly move air in a direction from the first device towards the second device.

2. The electro-magnetic air blower as claimed in claim 1, wherein the two devices include a tube housing and a plurality of rings.

3. The electro-magnetic air blower as claimed in claim 2, wherein the plurality of the rings include nine concentric rings.

4. The electro-magnetic air blower as claimed in claim 2, wherein a diameter of the tube is three inches.

5. The electro-magnetic air blower as claimed in claim 4, wherein a length of the tube is two inches.

6. The electro-magnetic air blower as claimed in claim 1, wherein the ratio is at least 30 to 1.

7. The electro-magnetic air blower as claimed in claim 6, wherein the ratio is 50 to 1.

8. The electro-magnetic air blower as claimed in claim 1, wherein the first device is positioned adjacent to an air filter of an internal combustion engine.

9. The electro-magnetic air blower as claimed in claim 8, wherein the second device is positioned adjacent to an intake manifold of the internal combustion engine.

10. The electro-magnetic air blower as claimed in claim 9, wherein the first device and the second device are located between the air filter and the intake manifold.

11. The electro-magnetic air blower as claimed in claim 10, wherein an engine management system controls an amount of the positive charge and negative charge passed to the two devices, respectively.
